(19) United States
(12) Patent Application Publication
(10) Pub. No.: US 2008/0005187 A1
(43) Pub. Date: Jan. 3, 2008

(54) Methods and apparatus for managing configuration management database via composite configuration item change history

(75) Inventors: Naga A. Ayachitula, Elmsford, NY (US); Krishna S. Garimella, San Jose, CA (US); Yan Or, San Francisco, CA (US); Larisa Shwartz, Scarsdale, NY (US)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 11/479,514

(22) Filed: Jun. 30, 2006

(51) Int. Cl. G06F 17/30

(52) U.S. Cl. 707/200

(57) ABSTRACT

Methods and apparatus for managing a configuration management database is provided. One or more composite CIs in the CMDB are utilized as fundamental units for change history management of elements of the CMDB. Each of the one or more composite CIs comprise at least one root element.

### CROSS REFERENCE TO RELATED APPLICATIONS

This application is related to: the U.S. patent Application Attorney Docket No. YOR920060467US1, entitled “Methods and Apparatus for Composite Configuration Item Management in Configuration Management Database;” the U.S. patent Application Attorney Docket No. YOR920060468US1, entitled “Methods and Apparatus for Global Service Management of Configuration Management Databases;” the U.S. patent Application Attorney Docket No. YOR920060469US1, entitled “Methods and Apparatus for Automatically Creating Composite Configuration Items in Configuration Management Database;” the U.S. patent Application Attorney Docket No. YOR920060477US1, entitled “Methods and Apparatus for Scoped Role-Based Access Control” which are filed concurrently herewith and incorporated by reference herein.

### FIELD OF THE INVENTION

The present invention relates to information technology (IT) systems and, more particularly, methods and apparatus for managing a configuration management database (CMDB) utilizing composite configuration items (CIs) as fundamental units for change history management.

### BACKGROUND OF THE INVENTION

Large and complex IT service management environments that provide multiple services to a plurality of customers can create an unmanageable number of entities. CMDB CIs represent an extensive range of logical and physical entities and their complex relationships. A typical implementation of a CMDB may contain more than 800 abstract object classes, with implicit and explicit relationships between them that may be extended in an open-ended fashion. Organizing entities into dependency trees or graphs for a high-level view of the topology eases system management. A CMDB is broad and semantically rich enough that it may apply to higher layers such as, for example, a business process or a distributed application. A CMDB is also granular enough to represent, for example, tables in a database or enterprise Java beans (EJBs) used in an enterprise application. In real-world enterprise systems, there may be tens of thousands or more entities with complex relationships between them. Compositions are ideally suited to multi-layered topologies.

The more levels in a CMDB, the more information there is to be handled. This results in larger and more complex CMDB elements. The fewer levels in a CMDB, the less control and information there are about the IT infrastructure. If the CMDB scope is too narrow, important parts of the infrastructure are not easily checked. If the CMDB scope is too wide, the cumbersome database will be an obstacle that slows down all service and management processes. If there are too many levels, attributes, and relationships, it will take processes a great effort to maintain the CMDB. Too little detail can mean recording insufficient information about the CI's and related incidents, problems, symptoms and requests for change (RFC).

A good framework for managing controls enables an auditor to review specific IT processes against control objectives to determine where controls are sufficient or advise management where processes need to be improved. Models assist in benchmarking and decision-making for control over IT. A typical goal is to proactively monitor audit results and IT metrics on an ongoing basis to focus the scope of audits on high-risk processes and tasks where performance indicators indicate potential problems. Results of analysis are presented to management on a periodic basis via management reports. The analysis indicates any changes to the audit scope planned for upcoming audits.

### SUMMARY OF THE INVENTION

In accordance with the aforementioned and other objectives, the embodiments of the present invention are directed towards methods and apparatus for CMDB management through utilization of composite CIs as fundamental units for change history management.

For example, in one aspect of the present invention a method of managing a configuration management database is provided. One or more composite CIs in the CMDB are utilized as fundamental units for change history management of elements of the CMDB. Each of the one or more composite CIs comprise at least one root element.

In additional embodiments of the present invention, change propagation rules for change history management are externalized to a propagation registry. Notifications generated for each change in the one or more composite CIs are propagated to the root element of the composite CI and one or more elements of the CMDB related to the root element. A change record may also be created indicating a change occurred, and a composite change record may be created that aggregates change records associated with a composite CI. A change history may be reviewed against IT system objectives to form audit results.

In accordance with embodiments of the present invention, a mechanism is provided instrumented into a service aware CMDB solution where a composite CI forms a fundamental manageable unit for configuration control through change history management. A group of related CIs represented as a composite CI simplifies management and makes it more intuitive, which facilitates this transformation to extend the CMDB into the emerging era of services computing and IT service management.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating composite CIs, according to an embodiment of the present invention;

FIG. 2 is a diagram illustrating template-based composite CIs, according to an embodiment of the present invention;

FIG. 3 is a diagram illustrating a diagram illustrating composite change history components, according to an embodiment of the present invention;

FIG. 4 is a flow diagram illustrating a CMDB management methodology using composite CIs as fundamental units for change history management, according to an embodiment of the present invention; and

FIG. 5 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

As will be described in detail below, the embodiments of the present invention introduce techniques for managing a CMDB utilizing composite CIs as fundamental units for change history management of elements of the CMDB.

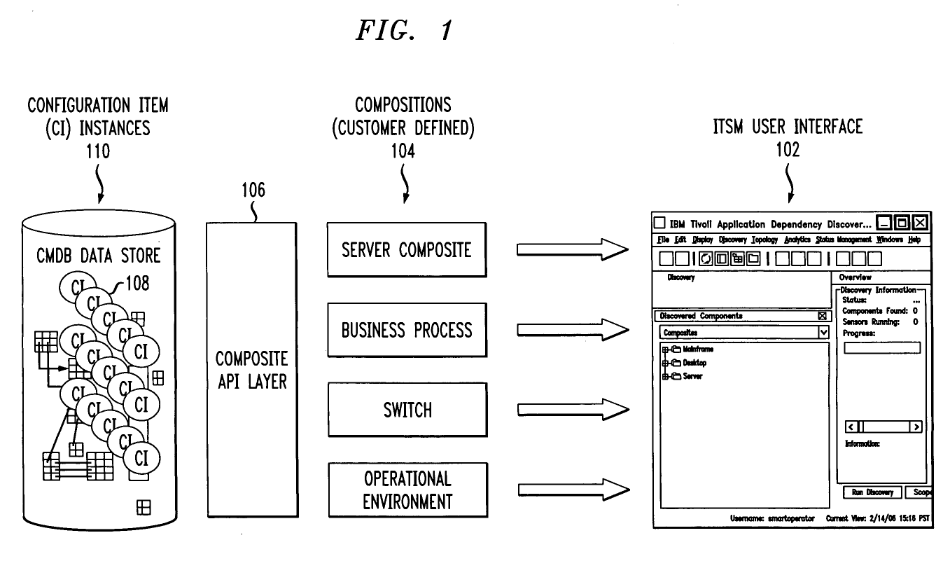

Referring initially to FIG. 1, a diagram illustrates composite CIs, according to an embodiment of the present invention. A user, at user interface 102, views a composite CI 104 from composite API layer 106 no differently than an atomic CI 108 from data layer 110. As a result, composite CIs 104 are modeled in the same way as atomic CIs 108. However, composite CIs 104 exist as distinct elements in the CMDB database.

Composite CIs are represented as a graph of supporting elements, which may be composite or atomic CIs. The graph is constructed by navigating relationships based on the definition of what composed the CI. The definition will be for the maximal graph that can make up the composite. Not all possible supporting elements are required in the composite CI in order to have a valid composition; only the root element is required.

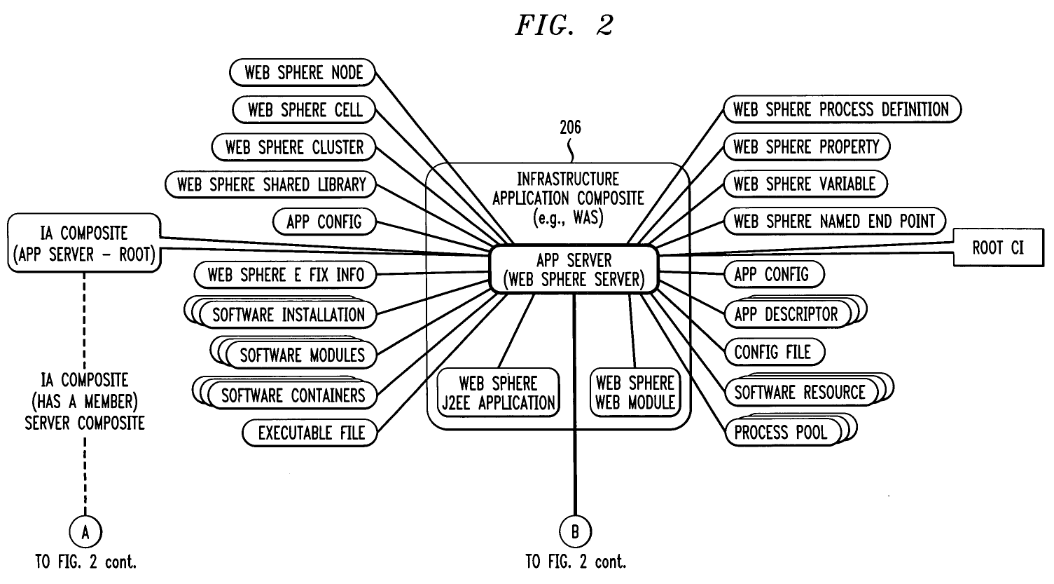

Referring now to FIG. 2, a diagram illustrates template-based composite CIs, according to an embodiment of the present invention. An example of a CI that is a composition of smaller entities, some of which are CIs themselves, is a server composite 202. A server composite 202 is made up of hardware 204, an operating system, installed and running software components, etc. An application composite 206 is also shown, and made up of software components and server composite 202 on which they run.

CIs can be composed by aggregating relationships to a main or root atomic CI. For example, a server has a root computer system object, which is related to hardware, operating system, software and networking elements. Further, an application has a root software system object that is related to underlying software components, which are in turn related to operating systems, software installations, software products, software updates, etc.

The identity of a composite CI is determined by the identity of its root atomic CI. Therefore, a root atomic CI must contain all the attributes necessary to identify the composite CI, even if some of those attributes are “derived” from supporting elements. Root CIs may be linked to other root CIs via “uses” or “contains” relationships.

A composite CI can exist as long as its root atomic CI can be uniquely identified. The supporting elements can be added to, removed from, or updated in the composition over time. Thus, for example a server composite may be created with only a computer system element. The operating system, hardware and networking elements may be added at any time, without changing the identity of the server CI itself.

Change propagation rules are externalized to a propagation registry that uses policies and/or rules. The change propagator uses the registry for propagation and exploits composite CIs to generate notifications and record change histories of configuration items. A composite CI is utilized as a fundamental unit of granularity for configuration management, which includes, for example, audits and reporting, change management, and security authorization management.

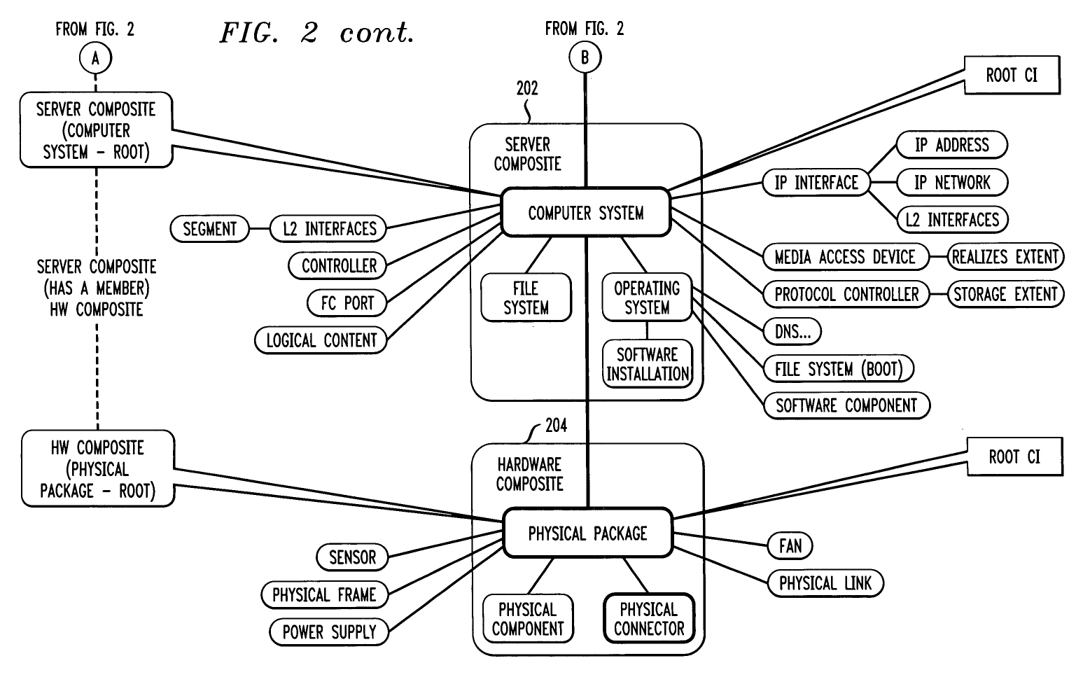

Referring now to FIG. 3, a diagram illustrates composite change history components, according to an embodiment of the present invention. Discovery sensors 302 supply CIs and compose an actual CI configuration 304. Actual CI configuration 304 is provided to configuration audit 306 along with composite configuration 308 and a change history 310 in order to produce audit results 312.

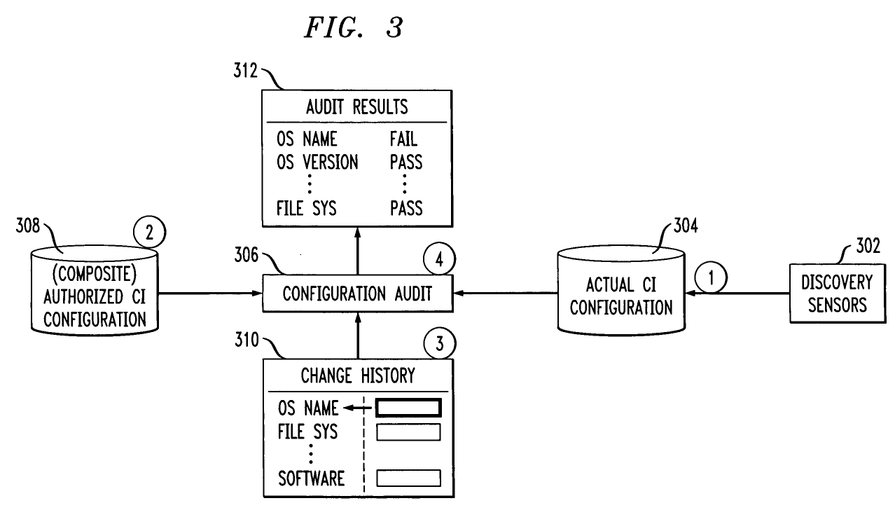

Referring now to FIG. 4, a flow diagram illustrates a CMDB management methodology using composite CIs as fundamental units for change history management, according to an embodiment of the present invention. The methodology begins at block 402, where notification of a change is produced in a CI. The notification is propagated to a root CI of the CI in block 404. In block 406, the notification is further propagated to any parent root CIs of the root CI. In block 408, the notification is propagated to CIs related to the root CI.

Whenever a configuration item is changed, a change report is created with the changes, such as, for example, attributes or relationships. The change record is stored in the CMDB. In block 410, a change record is created indicating a change occurred in a CI and/or a root CI. In block 412, a composite change record is constructed aggregating change records associated with a composite CI. Since a composite CI is constructed via a definition in a template for the composite CI, the change records for and about CI and attributes that are not in the template but are inherently defined in the containment model are ignored. In block 414, the composite change record is reviewed against system objectives to form audit results.

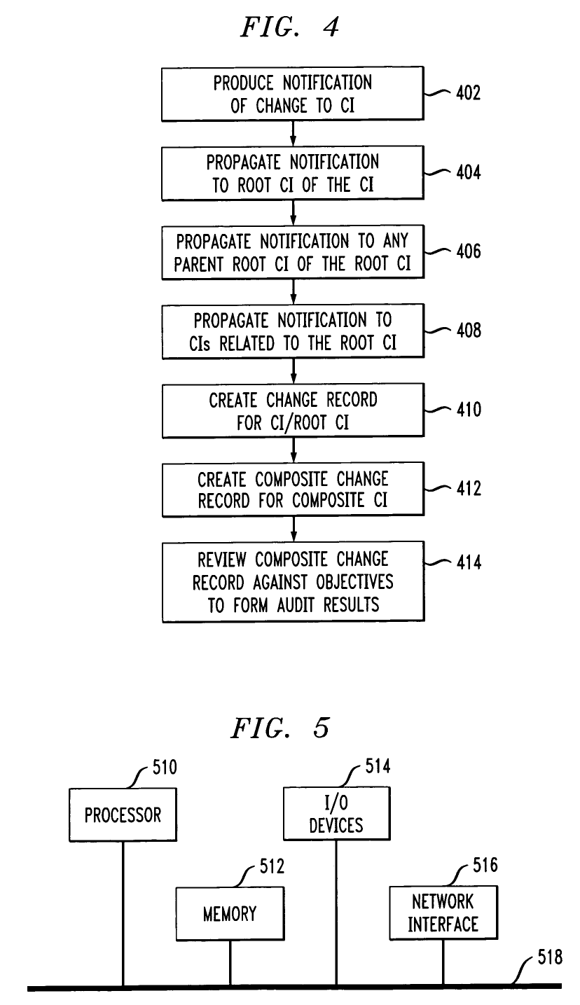

Referring now to FIG. 5, a block diagram illustrates an exemplary hardware implementation of a computing system in accordance with which one or more components/methodologies of the invention (e.g., components/methodologies described in the context of FIGS. 1-4) may be implemented, according to an embodiment of the present invention.

As shown, the computer system may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of managing a configuration management database comprising the step of utilizing one or more composite configuration items in the configuration management database as a fundamental unit for change history management of elements of the configuration management database, wherein each of the one or more composite configuration items comprise at least one root element.

2. The method of claim 1, wherein, in the step of utilizing one or more composite configuration items, change propagation rules for change history management are externalized to a propagation registry.

3. The method of claim 2, wherein the propagation registry comprises controlled configuration items of the configuration management database.

4. The method of claim 1, wherein, in the step of utilizing one or more composite configuration items, the at least one root element comprises a top level element of the composite configuration item comprising relationships to one or more other configuration items of the configuration management database.

5. The method of claim 4, wherein the at least one root element comprises a relationship with one or more other root elements corresponding to a composite configuration item of the configuration management database.

6. The method of claim 1, wherein the step of utilizing one or more composite configuration items comprises the step of generating one or more notifications for each change in the one or more composite configuration items.

7. The method of claim 6, wherein the step of generating one or more notifications comprises the step of propagating a notification of a change to a configuration item of a composite configuration item to a root element of the composite configuration item.

8. The method of claim 7, wherein the step of generating one or more notifications further comprises the step of propagating the notification of a change to a configuration item of a composite configuration item to one or more parent root elements of the root element.

9. The method of claim 7, wherein the step of generating one or more notifications further comprises the step of propagating the notification of a change to a configuration item of a composite configuration item to one or more elements of the configuration management database having a relationship with the root element of the composite configuration item.

10. The method of claim 6, further comprising the step of creating a change record to indicate that a change occurred to at least one of a root element and one or more elements of composite configuration item.

11. The method of claim 10, wherein the step of creating a change record further comprises the step of creating a composite change record comprising a compound construct aggregating two or more change records associated with a composite configuration item.

12. The method of claim 1, comprising the step of reviewing a change history against objectives to form audit results.

13. The method of claim 12, wherein the audit results comprise at least one of control sufficiency, management advice, and decision-making models.

14. Apparatus for managing a configuration management database, comprising:
a memory; and
at least one processor coupled to the memory and operative to utilize one or more composite configuration items in the configuration management database as a fundamental unit for change history management of elements of the configuration management database, wherein each of the one or more composite configuration items comprise at least one root element.

15. The apparatus of claim 14, wherein the operation of utilizing one or more composite configuration items comprises the operation of generating one or more notifications for each change in the one or more composite configuration items.

16. The apparatus of claim 15, wherein the operation of generating one or more notifications comprises the operation of propagating a notification of a change to a configuration item of a composite configuration item to a root element of the composite configuration item.

17. The apparatus of claim 15, wherein the at least one processor is further operative to create a change record to indicate that a change occurred to at least one of a root element and one or more elements of composite configuration item.

18. The apparatus of claim 17, wherein the operation of creating a change record further comprises the operation of creating a composite change record comprising a compound construct aggregating two or more change records associated with a composite configuration item.

19. The apparatus of claim 14, wherein the at least one processor is further operative to review a change history against objectives to form audit results.

20. An article of manufacture for managing a configuration management database, comprising a machine readable medium containing one or more programs which when executed implement the step of utilizing one or more composite configuration items in the configuration management database as a fundamental unit for change history management of elements of the configuration management database, wherein each of the one or more composite configuration items comprise at least one root element.
